(19) United States
(12) Patent Application Publication
(10) Pub. No.: US 2005/0248722 A1
(43) Pub. Date: Nov. 10, 2005

(54) Interactive eye glasses

(76) Inventor: Thomas J. Nelis, Holland, MI (US)

Correspondence Address: King & Jovanovic, PLC, 170 College Avenue, SUITE 230, HOLLAND, MI, 49423, US

(21) Appl. No.: 10/838,716

(22) Filed: May 4, 2004

(51) Int. Cl. G02C 7/02

(52) U.S. Cl. 351/159

(57) ABSTRACT

Interactive eye glasses comprising a frame, at least one lens and a display. The frame includes at least one lens support, a pair of opposing leg members and a display assembly coupling member. The pair of opposing leg members are coupled to the lens support. The display assembly coupling member is associated with at least one of the lens support and at least one of the pair of opposing leg members. The at least one lens is coupled to the lens support. The display assembly comprises a display screen, a control circuitry and a power means. The display screen is capable of displaying one of images and alpha-numeric characters and is coupled to the display assembly coupling member. The control circuitry is electronically coupled to the display screen. The power means is capable of electrically powering the control circuitry and display screen.

### BACKGROUND OF THE INVENTION

1. Field of the Invention

The present invention relates in general to eye glasses, and more particularly, to eye glasses which include an interactive component which enhance the utility and the usefulness of same.

2. Background Art

The use of eye glasses, either in the form of sunglasses, corrective lenses, or as fashion accessories is well known in the art. Such eye glasses generally include a frame and lenses associated with the frame. In certain embodiments, modifications have been made to certain surfaces to provide a region upon which text or images can be printed for display. Such eye glasses are commonly distributed as promotional material.

While such eye glasses are common, they do not generally attract the attention of an electronic display. Moreover, such eye glasses are commonly not configured in a manner in which the message (i.e., text or images) can be changed, selected from a group of preprogrammed messages or otherwise altered.

Accordingly, it is an object of the invention to overcome the deficiencies of the prior art.

It is an object of the invention to provide a display which is coupled to a frame of eye glasses.

It is a further object of the invention to increase the utility of conventional eye glasses.

These and further objects of the invention will become apparent in light of the specification and claims appended hereto.

### SUMMARY OF THE INVENTION

The invention comprises interactive eye glasses comprising a frame, at least one lens and a display. The frame includes at least one lens support, a pair of opposing leg members and a display assembly coupling member. The pair of opposing leg members are coupled to the lens support. The display assembly coupling member is associated with at least one of the lens support and at least one of the pair of opposing leg members. The at least one lens is coupled to the lens support. The display assembly comprises a display screen, a control circuitry and a power means. The display screen is capable of displaying one of images and alpha-numeric characters and is coupled to the display assembly coupling member. The control circuitry is electronically coupled to the display screen. The power means is capable of electrically powering the control circuitry and display screen.

In a preferred embodiment, the lens support comprises a pair of spaced apart lens supports wherein each of the opposing leg members coupled to one of the lens supports. In another preferred embodiment, the frame further comprises a bridge positioned between the pair of spaced apart lens supports. Furthermore, the at least one lens comprises a pair of spaced apart lenses.

In another preferred embodiment, the display assembly coupling member is positioned above the at least one lens support, such that at least a portion of the display screen is positioned above the at least one lens.

In another embodiment, the control circuitry is attached to the frame.

Preferably, the control circuitry comprises an input, an output positionable in electronic communication with the display screen, a processor electronically coupled to each of the input and the output, and memory electronically with the processor.

In one such embodiment, the input comprises a port capable of communicating with one of an input peripheral and a second device. In one such embodiment, the second device comprises one of the group consisting of: a PDA, a mobile phone and a computer. In another such embodiment, the input peripheral comprises a keyboard and a plurality of buttons. Preferably, the memory further comprises a flash memory card.

In yet another preferred embodiment, at least a portion of the display assembly is releasably coupled to the frame. In one such embodiment, the display screen is releasably coupled to the frame.

In another such embodiment, the display screen comprises a LED display capable of displaying a plurality of alpha-numeric characters. However, in other embodiments, the display screen comprises a LCD display.

In another aspect of the invention, the invention comprises a method of displaying a message on interactive glasses. In such an aspect of the invention, the interactive glasses include a frame, at least one lens coupled to the frame and a display assembly coupled to the frame. The method comprises the steps of: providing a message to display; inputting the message into a control circuitry of the display assembly; and displaying the message on a display screen of the display assembly.

In one embodiment, the step of inputting comprises the step of selecting from among a plurality of pre-programmed messages within the display assembly.

In another embodiment, the step of inputting comprises the step of: associating one of a peripheral and a second device with the control circuitry of the display assembly, and, transferring the message from the peripheral or second device to the display assembly.

### BRIEF DESCRIPTION OF THE DRAWINGS

The invention will now be described with reference to the drawings wherein:

FIG. 1 of the drawings comprises a perspective view of an embodiment of the present invention;

FIG. 2 of the drawings comprises a front plan view of the present invention, showing in particular the display screen of same;

FIG. 3 of the drawings comprises a perspective view of an embodiment of the present invention, showing, in particular detachable display assembly components; and

FIG. 4 of the drawings comprises a perspective view of an embodiment wherein the control circuitry and power means of the display assembly is detached from the frame.

### DETAILED DESCRIPTION OF THE INVENTION

While this invention is susceptible of embodiment in many different forms, there is shown in the drawings several specific embodiments with the understanding that the present disclosure is to be considered as an exemplification of the principles of the invention and is not intended to limit the invention to the embodiments illustrated.

It will be understood that like or analogous elements and/or components, referred to herein, are identified throughout the drawings by like reference characters. In addition, it will be understood that the drawings are merely representations of the present invention, and some of the components may have been distorted from actual scale for purposes of pictorial clarity.

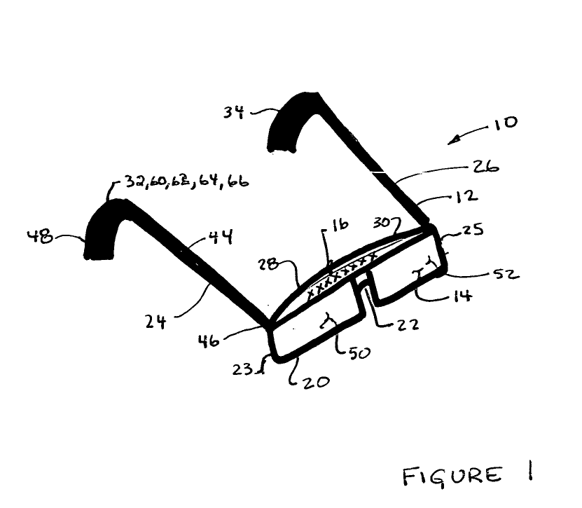

Referring now to the Figures, and in particular to FIG. 1, interactive eye glasses 10 comprise frame 12 and lens assembly 14 and display assembly 16. It will be understood that the eye glasses may comprise any one of sunglasses, reading glasses or conventional eye glasses (i.e., monofocals, bifocals, and/or trifocals). It is contemplated that frame 12 comprise a metal, alloy, polymer and/or composite material. Indeed, the invention is not limited to any particular configuration.

Frame 12 is shown in FIG. 1 as comprising lens support 20, bridge 22, opposing leg members 24, 26 and display assembly coupling member 28. Lens support 20 is shown in FIG. 1 as comprising a pair of spaced apart members 23, 25, which are capable of retaining lens assembly 14. In the embodiment shown, the lens support comprises two hoops which extend about the circumference of each lens of the lens assembly. In other embodiments, lens support may comprise mounting members which accept fasteners coupled to the lenses. In other embodiments, a press fit structure may be employed to retain the lens assembly. Of course, the application is not limited to the use of any particular lens support structure, and any number of different structures are contemplated for use.

Bridge 22 is shown in FIG. 1 as extending between members 23, 25 of lens support 20. It will be understood that any number of different structures are contemplated, including structures which include padding intended to couple with the nose of a user.

Opposing leg members 24, 26 are shown in FIG. 1. Opposing leg member 24 will be described with the understanding that opposing leg member 26 is substantially identical thereto. Accordingly, opposing leg member 24 includes body 44 having first end 46 and second end 48. First end 46 is coupled to opposing member 23 of lens support 20 (or, in other embodiments, to bridge 22). In certain embodiments, first end 46 may be hingedly attached to the lens support, whereas in other embodiments, it may be fixed to the lens support. Second end 48 includes structures which facilitate coupling of the leg member with the ear of a user. For example, second end 48 may comprise a configuration which extends about the interface between the ear and the head of a user. Body 44 includes a cross-sectional configuration, a predetermined length, width and depth. Indeed, the size of body 44 can be varied for purposes of fashion or structurally to support and/or contain various features of display assembly 16 (as will be explained below).

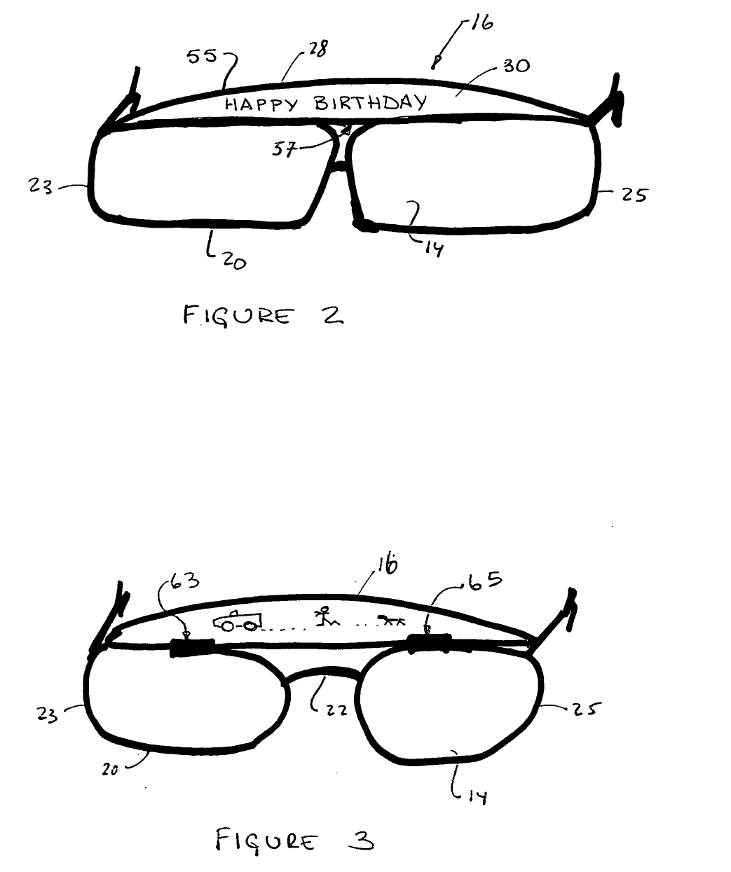

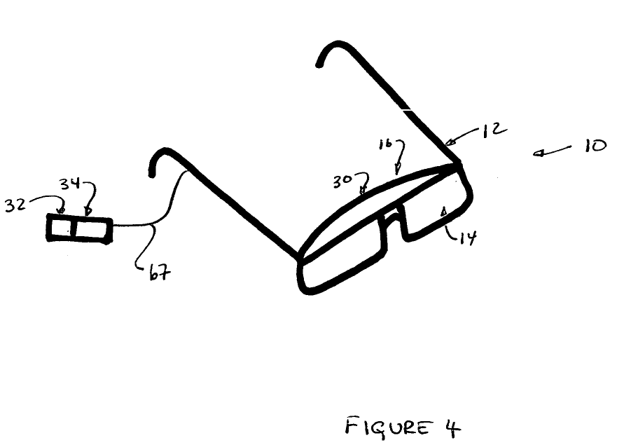

Display assembly coupling member 28 is shown in FIG. 2, as comprising first member 55, and second member 57. The first and second members 55, 57, in cooperation with members 23, 25 of lens support 20 define a structure to which display screen 30 (as will be described below in detail) may be attached. The coupling member provides a border around the display screen to protect same from impact or other destruction. In the embodiment shown, the display assembly coupling member is positioned above the lens support members. In other embodiments, the display assembly coupling member may comprise the lens support, the bridge and/or the opposing leg members without separate components. In one embodiment, shown in FIG. 3, the display assembly coupling member can be integrated with the display screen but can be releasably attached to frame 12 by attachment members 63, 65, thereby facilitating the removal and replacement of the display screen as desired. In another embodiment, the display assembly coupling member, and, in turn, the display can be associated with the leg members (i.e., the display may be integrated with, for example, wide leg members).

Lens assembly 14 is shown in FIG. 1 as comprising opposing lenses 50, 52. Each of the lenses are attached to frame 12 by way of lens support 20. In certain embodiments, lenses 50 and 52 may be integrated into a single lens member. One such configuration is available from Oakley Corporation under the brand name Blades. In other configurations, the lenses may comprise separate and discrete members. The lenses may include tinting (i.e., sunglasses), prescription lenses (mono, bi or tri focal), or may comprise a conventional lens without tinting and/or magnification.

Display assembly 16 is shown in FIG. 1 as comprising display screen 30, control circuitry 32 and means 34 for supplying power for the display assembly. Display screen 30 comprises a member capable of displaying images and text. In the embodiment shown, the screen comprises an alpha-numeric screen capable of displaying a number of characters across a single line. Of course, other embodiments are likewise contemplated. For example, the display screen may comprise an alpha-numeric LED display having one or more lines, a LCD display having varying pixel resolution and depth (inorganic or organic), OLED's, both active and passive displays, among others. The display assembly can be permanently affixed to frame 12, or may be detachably associated therewith (FIG. 3). In one embodiment, the display assembly can project an image onto another surface of the eye glasses, such as, for example the lenses, among others.

The display screen is coupled to control circuitry 32. Control circuitry includes input means 60, output means 62, processing means 64 and storage means 66. Input means 60 may comprise an integrated or attachable keyboard which can be selectively attached to the control circuitry to introduce a message into storage means 66 thereof. Alternatively, the input means may comprise a communication port capable of interfacing with another component. For example, the communication port may comprise any one of a USB connector, a Bluetooth adapter, a LAN adapter, an IR port, an RF port, any combination of these ports, among others. Such ports are capable of association with another device such as a phone, a PDA, a computer, among others, and are capable of transmitting bidirectional data therebetween. Output means 62 comprises a port which is electronically coupled with display screen 30 and which is capable of prompting and/or directing the display on the display screen. Preferably, control circuitry 32 is integrated with frame 12, such as, opposing by member 24. Of course, as other technologies develop, control circuitry can be further simplified so long as the function thereof remains accomplished.

Processing means 64 may comprise a suitable microprocessor and associated chipset. Inasmuch as the complexity of the display screen and the messages displayed thereon may be varied, the processing means can be varied from very basis processing means (i.e., 4 bit processors, etc.) to more advanced processing means (i.e., 8 bit or greater processors). Of course, other simplified integrated circuits are contemplated for use, and the invention is not limited to a particular type of processing means.

Storage means 66 may comprise volatile and/or non-volatile (i.e., flash) memory which may be permanently associated with the processing means. Additionally, provision may be made for use of flash based memory cards (i.e., CF, SD, MS, xD and SM, among others) to supplement the base memory.

Power means 34 may comprise one or more primary or secondary batteries. For example, one or more button cells, or larger may be provided to energize the display assembly. The capacity of the power means must be such that it can drive the control circuitry and the display screen for a desired period of time. Preferably, power means 34 can be integrated with frame 12, such as with opposing leg member 26.

In another embodiment, as is shown in FIG. 4, each of control circuitry 32 and power means 34 may be positioned within a separate housing which is linked by link 67 electronically with display screen. In certain embodiments, such a link may be wireless, or may be wired. Of course, other configurations are likewise contemplated for use.

In operation, a user can first utilize input means 62 to input a desired message for display into the control circuitry. This may be achieved through direct input, or through communication between control circuitry 32 and a second device such as a computer, a PDA, a mobile phone, among others. In other embodiments, the memory of control circuitry 32 may include a number of pre-programmed messages and the user utilizing input means 62 selects a desired one or more of the pre-programmed messages.

Once the desired message or series of messages is selected or input, the display assembly can be activated so that the message is displayed upon the display screen 30. As the message is appearing, the user can wear the glasses in much the same manner in which conventional glasses are utilized.

The foregoing description merely explains and illustrates the invention and the invention is not limited thereto except insofar as the appended claims are so limited, as those skilled in the art who have the disclosure before them will be able to make modifications without departing the scope of the invention.

1. Interactive eye glasses comprising:
a frame having:
at least one lens support;
a pair of opposing leg members coupled to the lens support; and
a display assembly coupling member associated with at least one of the lens support and at least one of the pair of opposing leg members;
at least one lens coupled to the lens support; and
a display assembly comprising:
a display screen capable of displaying one of images and alpha-numeric characters, the display screen coupled to the display assembly coupling member;
control circuitry electronically coupled to the display screen; and
means for electrically powering the control circuitry and display screen.

2. The interactive eye glasses of claim 1 wherein:
the lens support comprises a pair of spaced apart lens supports, each of the opposing leg members coupled to one of the lens supports;
the frame further comprises a bridge positioned between the pair of spaced apart lens supports; and
the at least one lens comprises a pair of spaced apart lenses.

3. The interactive eye glasses of claim 1 wherein the display assembly coupling member is positioned above the at least one lens support, such that at least a portion of the display screen is positioned above the at least one lens.

4. The interactive eye glasses of claim 1 wherein the control circuitry is attached to the frame.

5. The interactive eye glasses of claim 1 wherein the control circuitry comprises:
an input;
an output positionable in electronic communication with the display screen;
a processor electronically coupled to each of the input and the output; and
memory electronically with the processor.

6. The interactive eye glasses of claim 5 wherein the input comprises a port capable of communicating with one of an input peripheral and a second device.

7. The interactive eye glasses of claim 6 wherein the second device comprises one of the group consisting of: a PDA, a mobile phone and a computer.

8. The interactive eye glasses of claim 6 wherein the input peripheral comprises a keyboard and a plurality of buttons.

9. The interactive eye glasses of claim 5 wherein the memory further comprises a flash memory card.

10. The interactive eye glasses of claim 1 wherein at least a portion of the display assembly is releasably coupled to the frame.

11. The interactive eye glasses of claim 10 wherein the display screen is releasably coupled to the frame.

12. The interactive eye glasses of claim 1 wherein the display screen comprises a LED display capable of displaying a plurality of alpha-numeric characters.

13. The interactive eye glasses of claim 1 wherein the display screen comprises a LCD display.

14. A method of displaying a message on interactive glasses, the interactive glasses having a frame, at least one lens coupled to the frame and a display assembly coupled to the frame, the method comprising the steps of:
providing a message to display;
inputting the message into a control circuitry of the display assembly; and
displaying the message on a display screen of the display assembly.

15. The method of claim 14 wherein the step of inputting comprises the steps of:
selecting from among a plurality of pre-programmed messages within the display assembly.

16. The method of claim 14 wherein the step of inputting comprises the step of:
associating one of a peripheral and a second device with the control circuitry of the display assembly; and
transferring the message from the peripheral or second device to the display assembly.
